(19) United States
(12) Patent Application Publication
(10) Pub. No.: US 2012/0258794 A1
(43) Pub. Date: Oct. 11, 2012

(54) Computer Game Creation System, Computer Game Support System and Method

(75) Inventors: Rodolfo Rosini, Woking (GB); Stéphane Bura, Woking (BE)

(73) Assignee: Namaste Entertainment Inc, Marina, CA (US)

(21) Appl. No.: 13/440,398

(22) Filed: Apr. 5, 2012

Related U.S. Application Data
(60) Provisional application No. 61/471,892, filed on Apr. 5, 2011.

(51) Int. Cl. A63F 13/12; A63F 13/02; A63F 13/10; A63F 13/00

(52) U.S. Cl. 463/29; 463/42; 463/31; 463/25

(57) ABSTRACT

A computer game support system, game design method and system is disclosed. A plot element data repository encodes an abstract representation of computer game plot elements. A gaming environment is provided to one or more clients in dependence on the abstract representation. Plot element data encodes blocks for forming the abstract representation of computer game plot elements, said blocks being interlinkable, each block representing a computer game element or an attribute of a computer game element, links between blocks defining relationships between said represented computer game elements or attributes.

### CROSS-REFERENCE TO RELATED PATENT APPLICATIONS

The present application claims priority to and the benefit of U.S. Patent Application No. 61/471,892 filed Apr. 5, 2011, which is hereby incorporated by reference in its entirety.

### FIELD OF THE INVENTION

The present invention relates to a computer game element creation system, computer game support system and corresponding methods that are particularly relevant to computer game environments supporting multiple authors of game elements.

### BACKGROUND TO THE INVENTION

Computer games are desirably attention seeking and capturing. If a player's attention strays from a game to some other activity too often, he or she may lose interest and stop playing the game. If this happens too frequently, he or she may consciously or subconsciously decide not to play the game again.
Prior to the growth of online gaming, a games company fully expected a game to have a maximum lifetime. A player would only play a game for a period of time before he or she became bored, found it too difficult to progress further or simply finished it. This lifetime supported the games company's economic model because it meant that at the end of the lifetime the player would likely be looking to purchase another game.
The advent of online gaming brought about a new economic model based around subscriptions. Many online games now require a player to have a subscription that is subject to a monthly fee in order to play a game. This has the advantage that a repeating revenue stream is created. However, it means that a fixed lifetime for a game is now detrimental because players would only maintain a subscription to game they are still playing.
Online games often are based around an extensible shell environment. The environment defines the world and its physics and other characteristics that may not change between stories. The gaming company then authors plotlines, stories, events for that environment. It is common for a game to have a major plotline and a number of side-plots.
Most online games are so-called massively multiplayer role playing games (MMRPGs) which support many players at one time. In such games, players can decide to play co-operatively to complete a story or plotline or in a single player mode in which the same stories or plotlines (potentially having a reduced difficulty) are played.
Despite the opportunity of the new economic model, few games companies have successfully extended the lifetime of their games. Typically, a games subscription will increase after launch to a peak and then drop off as garners move on to a different game leaving a residual hard-core and limited number of late-corners to the game. MMORPGs are complex, time consuming to produce and consequently expensive. In order to extract as much profit as possible from the investment, it is desirable that games be frequently extended such that a player's attention can be retained by new material. Desirably, it is not enough for the material just to be new, it must also be high quality and present new challenges to a player. There is clearly a cost-benefit balance to be struck as the more man-hours incurred on extending games, the less profit will be made from the subscriptions.
The few MMORPGs that have successfully extended their lifetimes have done so by extending the “world” to present new challenges to advanced users while maintaining the default challenges and plotline for new and inexperienced players. These extensions tend to be significant in size and effort and therefore only the most successful games have had more than a couple of extensions created.
Current game development tools make the designer content at the action level because of the assumption that designers want to retain absolute control over what happens in their story. But the price for controlling every action characters perform is that the designer has to predict and control every action, he or she has to code each character's behavior and reaction. For economic reasons, this limits what games can achieve.

### STATEMENT OF INVENTION

According to an aspect of the present invention, there is provided a computer game support system comprising:
a plot element data repository encoding an abstract representation of computer game plot elements; and,
a processor configured to execute computer program code for providing a gaming environment to one or more clients, the computer program code including:
computer program code configured to access said data repository and retrieve at least a part of said abstract representation;
computer program code configured to interpret said abstract representation to identify one or more objects associated said abstract representation and cause an operation in a computer game environment using said objects.
The abstract representation is preferably formed from a plurality of interlinkable blocks, each block representing a computer game element or an attribute of a computer game element, links between blocks defining relationships between said represented computer game elements or attributes.
The system may further comprise a game element data repository encoding rendering data on one or more of said computer game elements, the computer game support system including computer program code configured to cause retrieval of said rendering data associated with the or each computer game element and computer program code to cause rendering in the computer game environment using the rendering data.
The system may further comprise computer program code configured to operate a game store offering one or more purchasable elements to players of the game environment, the or each purchasable element having an associated abstract representation, wherein the computer game support system including computer program code configured to provide access to a player to said plot element in the computer game environment upon purchase via the game store.
The system may further comprise computer program code configured to cause movement of objects in the computer game environment in response to inputs received from a player, said movement being processed independently of said plot elements.
According to another aspect of the present invention, there is provided a computer implemented game creation system comprising:
a plot element data repository encoding blocks for forming an abstract representation of computer game plot elements, said blocks being interlinkable, each block representing a computer game element or an attribute of a computer game element, links between blocks defining relationships between said represented computer game elements or attributes; and,
a processor configured to execute computer program code for providing a user interface for manipulating and linking said blocks to form said abstract representation.
The user interface is preferably a graphical user interface, said system including computer program code configured to graphically link blocks in dependence on user inputs.
The system may include computer program code configured to accept user inputs on blocks to be selected to form said abstract representation.
The system may further comprise computer program code configured to restrict access to one or more of said blocks until payment is made by the user.
The system may further comprise a game data repository configured to receive and store an abstract representation created by a user, wherein game data repository is accessible by a computer game environment and is configured to provide stored abstract representations on demand to said game environment, said abstract representation being interpretable to cause a change in the game environment.
The system may further comprise computer program code configured to provide access to a stored abstract representation upon receipt of a payment.
According to another aspect of the present invention, there is provided a computer implemented game design method comprising:
storing, in a data repository, data encoding blocks for forming an abstract representation of computer game plot elements, said blocks being interlinkable, each block representing a computer game element or an attribute of a computer game element, links between blocks defining relationships between said represented computer game elements or attributes; and,
executing, by a processor, computer program code for providing a user interface for manipulating and linking said blocks to form said abstract representation.
The user interface is preferably a graphical user interface, said method including accepting user inputs to cause graphical linking of said blocks.
The method may further comprise receiving one or more user inputs on a block to be selected to form said abstract representation and displaying said selected block in the user interface.
The method may further comprise receiving one or more user inputs on a block in the abstract representation and causing movement of said selected block in the abstract representation, wherein chronology of the plot element is dependent on the position of the blocks in the abstract representation.
The method may further comprise executing computer program code in a processor to restrict access to one or more of said blocks until payment is made by the user.
The method may further comprise operating a game data repository configured to receive and store an abstract representation created by a user, wherein game data repository is accessible by a computer game environment, the method further comprising providing stored abstract representations on demand to said game environment, said abstract representation being interpretable to cause a change in the game environment.
The method may further comprise executing computer program code in a processor to provide access to a stored abstract representation upon receipt of a payment.

### BRIEF DESCRIPTION OF THE DRAWINGS

FIG. 1 is a schematic diagram of a computer program game system according to an embodiment of the present invention;

FIG. 2 is a schematic diagram of the computer game support system according to an embodiment of the present invention;

FIG. 3 is a schematic diagram of a computer game creation system according to an embodiment of the present invention; and,

FIGS. 4 to 12 are illustrations of graphical formation of a game element according to an embodiment of the present invention.

### DETAILED DESCRIPTION

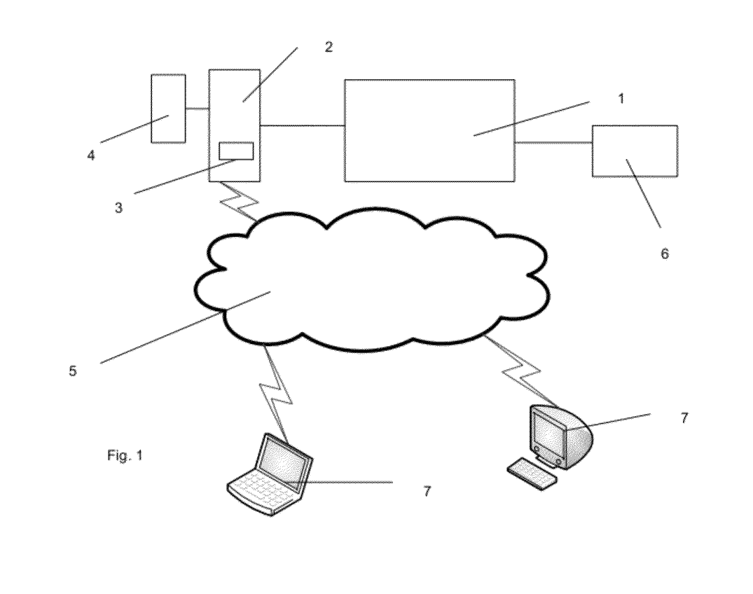

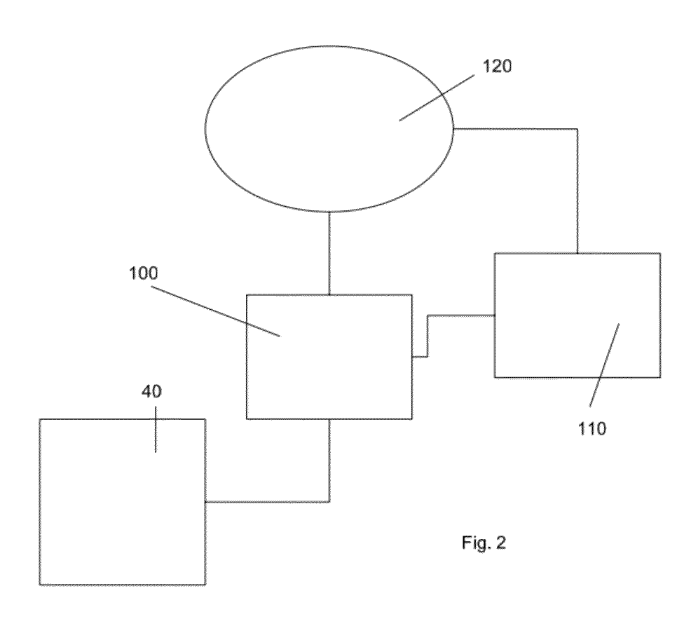

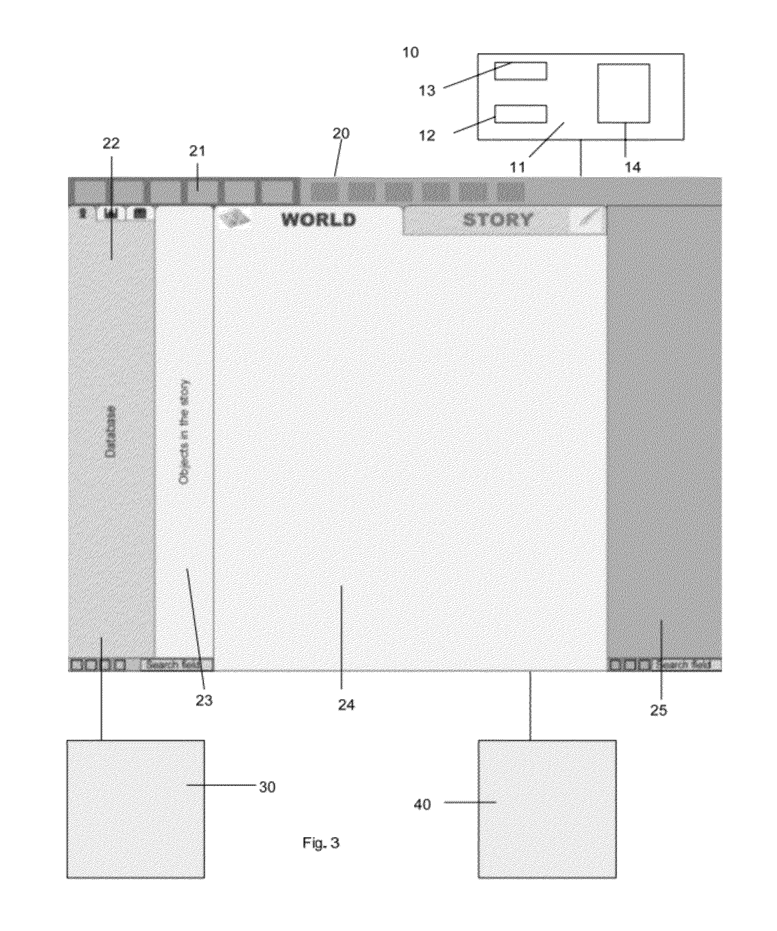

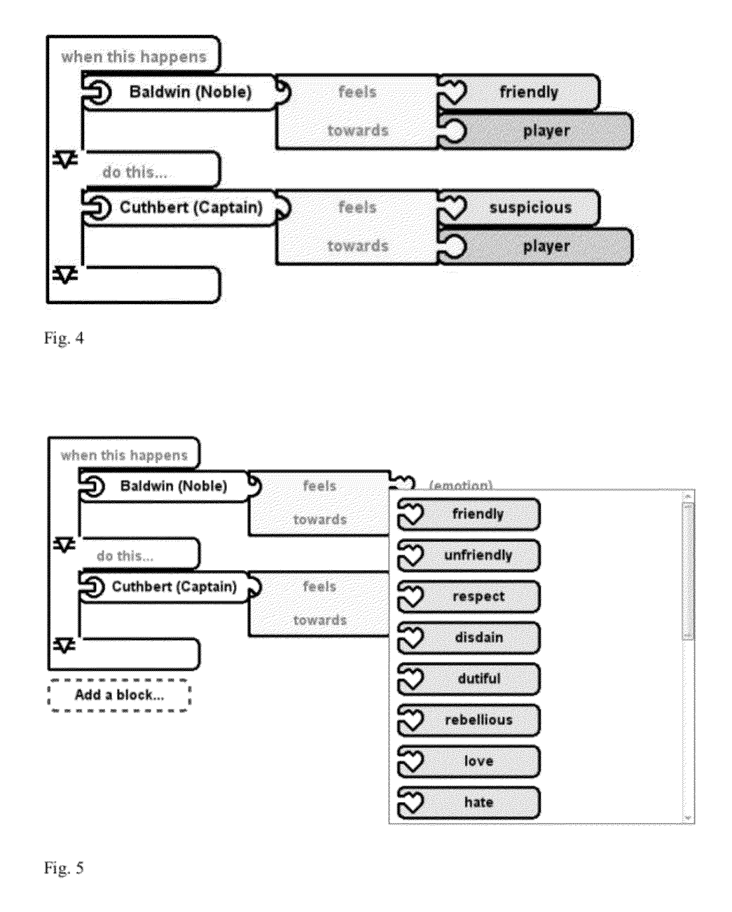

FIG. 1 is a schematic diagram of a computer program game system according to an embodiment of the present invention.
The game system 1 is typically executed at least in part by a central server 2 (or a distributed server system). The central server 2 includes a processor 3 coupled to a data repository 4 and a network 5. The central server 2 is configured to execute computer program code to operate a computer game support system 100. The central server system may also be configured to execute computer program code to operate a game store 6.
The game support system is configured to provide an online gaming environment to clients 7 connecting to the server 2 via the network 5 as set out in more detail below. Typically, rendering of the gaming environment is handled locally by the respective client 7, although some/all of this could be done by the server 2 or an associated component.
The server and game support system provide an extensible gaming environment as discussed below. Game plot is separated from physics, action and mechanics in the gaming environment such that the plot can be developed substantially independently of content (such as characters, objects, locations, abilities, physics). While there may be instances where it is desirable for a new plot line to be released into the environment at the same time as new characters (who may be key to the plot), in embodiments of the present invention these do not need to be developed as a contiguous unit and the character (or plot) could be recycled for use in another plot without further development work.
It will be appreciated that the game element store 6 and game support system 100 need not be provided by the same server/system and couple be separate components/systems configured to communicate with each other. In another embodiment, the game element store may enable creation of content which can subsequently be uploaded to the game support system 100.
FIG. 2 is a schematic diagram of the computer game support system according to an embodiment of the present invention.
The computer game support system 100 interfaces with a game element database 40 and a game engine 110 to provide the online gaming environment 120 (or enhancements to the online gaming environment 120).
When a player accesses the online gaming environment 120 via his or her client 7 and comes across the location in the world that a designer has designated to place a game element (during the design process discussed below), this is detected by the game support system 100 and causes the processor and server to trigger a representation of an accessible game element is to the player. For example, an entrance to a story may be a set of gates, a door to a building, a pathway etc that are rendered at the client 7. Representations may also include audio representations.
The game element database 40 may be self-contained or it may reference a content database 30 (discussed below) for its generation via the defined building blocks.
The game engine 110 runs the world itself, handles combat, interaction and the like but draws on the game element database 40 to produce the online gaming environment.
In preferred embodiments of the present invention, the computer game system 1 provides a distributed design methodology. Multiple independent designers may each be configured to access or contribute to the game support system 100. Designers may work on common projects or completely independently (to the extent that different independent worlds developed by common or different designers may be hosted by a common server). Designers are able to create and/or purchase (via the game store 6) game elements and make them available to players in the game world. Having placed a game element in the world, a designer may specify a charge for accessing the game element, a payment mechanism via the game store 6 may be invoked (such as an in-game store or in game payment mechanism). Payment by the player may result in a blockage being removed, door unlocked etc to access the game element.
FIG. 3 is a schematic diagram of a computer game creation system according to an embodiment of the present invention.
The game content creation system 10 includes a graphical editor 20 connectable to the content database 30 and the game element database 40. In one embodiment, the game content creation system is implemented as computer program code configured to execute on a computer system 11 having a processor 12, a memory 13 and a data store 14. The computer system 11 may be local to a designer (on his or her client machine) or remote (such as a remotely accessible server) or in some intermediate arrangement such as a client-server configuration in which some functions are executed locally to the designer and some remotely.
The graphical editor 20 enables a user to access content from the content database 30 and manipulate it to create a game element such as a story, plotline, item, non-player character or the like which can then be saved to the game element database 40 for access by players. In the example given below, a story is created from tasks, conditional requirements and non-player characters. However, it will be appreciated that the principles could be applied to any game element (and indeed, game elements could be created, saved back to the content database 30 and used as the base for future game elements).
In the illustrated embodiment, a small number of high level choices can generate an involving story. Plot choices can create interesting low level decisions for the player, even if the storyteller can edit the resulting story later on. The game system 1 interprets the game element to determine how it affects the rendered world and entities portrayed in the world (so for example if the story called for character Joe to be present at location X at time Y, the game system would handle take the necessary steps at the appointed time; similarly, the game engine 110 handles activities such as movement, combat and the like). In interpreting a game element, data on how to render it, how it may physically interact with other game elements (such as how much damage it does, how easily it is broken, moved) etc. is obtained from a source such as the content database 30. It will be appreciated that this data can be divorced from the plot and plot design.
In embodiments of the present invention, high level choices by the designer in the content creation system 10 are enough to create engrossing stories. However, devoted storytellers do have the tools to make subtle meaningful variations or even to build very detailed stories from the ground up.
In one embodiment, the graphical editor is based around the Scratch programming language described at http://en.wikipedia.org/wiki/Scratch (programming language) and which is herein incorporated by reference.
Although scratch is a programming language, it simplifies many areas. For example, you cannot make syntax errors. Blocks are selected from the content database 20 and combined to make what you want, with instantaneous feedback after each modification.
Embodiments of the present invention offer designers a different approach to game development. Designers delegate control over the minute behaviours to the game engine and, in exchange, they get to design at the abstraction level that matters for stories: the one that describes desires, goals, relationships, emotions, drives, etc. While a designer may never know exactly how the design will be instantiated, he or she retains a high level of control over the story itself. For instance, if you want the captain to become suspicious of the player if he befriends the noble, it's as simple as placing the blocks as set out in FIG. 4.
In a preferred embodiment again shown in FIG. 3, the graphical editor has a ribbon of icons 21 for commands. List panes include a database list 22 that is linked to the content database 30 and contain items that can be added to the main panes 24, 25, where the story is shown. Lists can be sorted and filtered. These lists are:

### Database (22)

This list contains all the content from the database 30 such as objects that the designer can use in his story. In one embodiment, these are divided in three tabs: people, places and things.
The graphical editor 20 shows which of these are free or owned by the designer, and which must be purchased (via the game store 6, for example as an in-application purchase or an external purchase) if the designer wants to publish a story that contains them.
As such, the database may, for example, include pre-created characters (ranging from “filler” such as simple soldiers, townsfolk and other inhabitants of the world to more complex characters that exhibit intelligence, feelings and emotions that could be central to a story), character attributes (enhancements to abilities, artificial intelligence routines, personalities, clothing), objects (weapons, quest items, food, furniture, traps, puzzles), world elements (locations, buildings, physics attributes or other enhancements to an existing world element). It will be appreciated that the database may evolve over time and designers may be permitted to submit their own creations to the database for sale through the store. For example, a designer may purchase a generic human male, design clothes, personality and attributes and submit this more developed and complex element to the database for purchase by others.

### Objects in the Story (23)

All the objects selected by the designer are preferably put in this list, for easy access. They become blocks that can be used to design the plot.

### Plot Blocks

This list contains all the blocks that let the designer structure a plot and give it flavour such as plots, sub-plots, dialogues, conversation options for characters.
As with the database, some blocks can optionally require purchasing before they can be used in a published story.
The two central tabs in which the story is shown are:

### World (24)

This is an optional component. A map is shown where the designer can put characters, places and things taken from the database. The map may be 2D or 3D.

### Story (25)

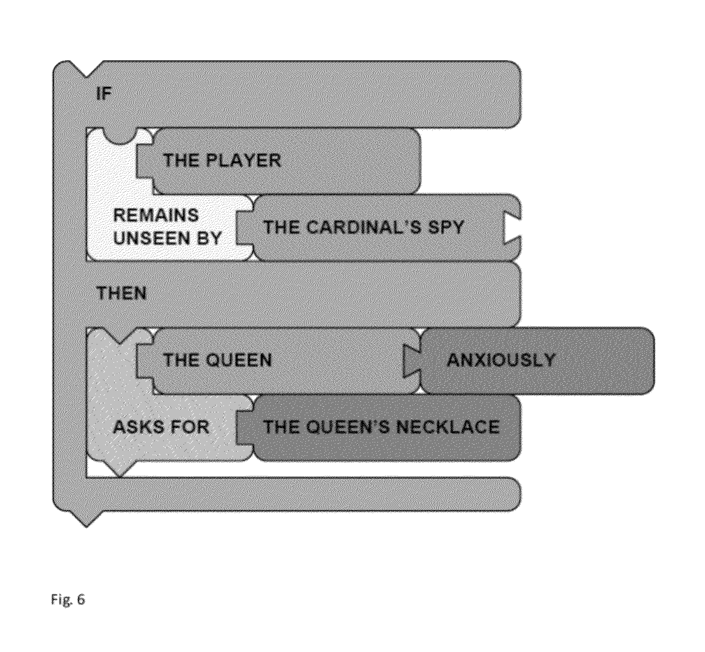

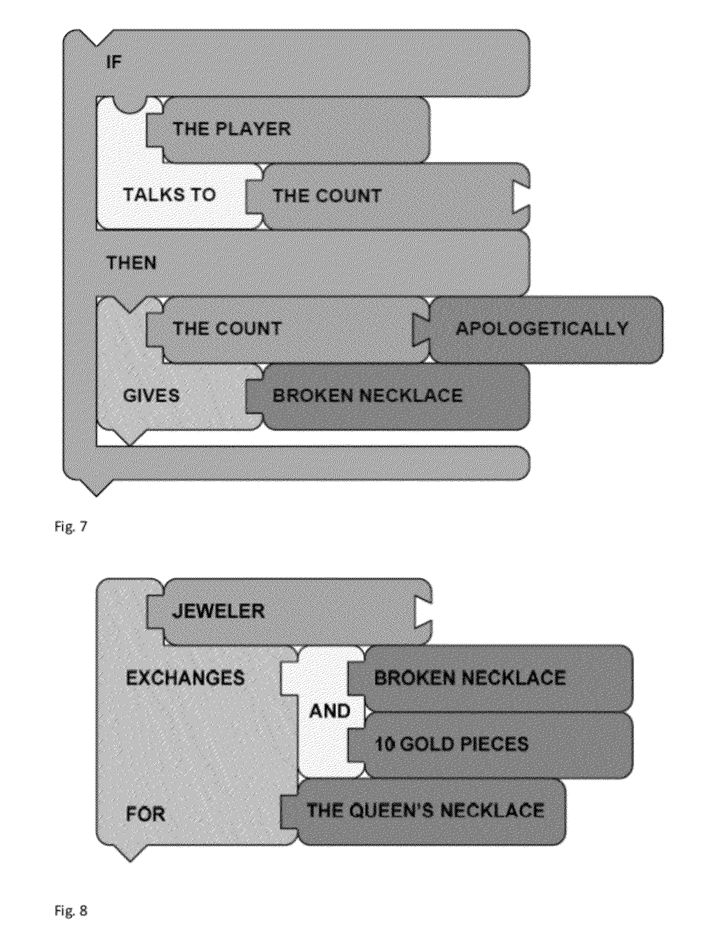

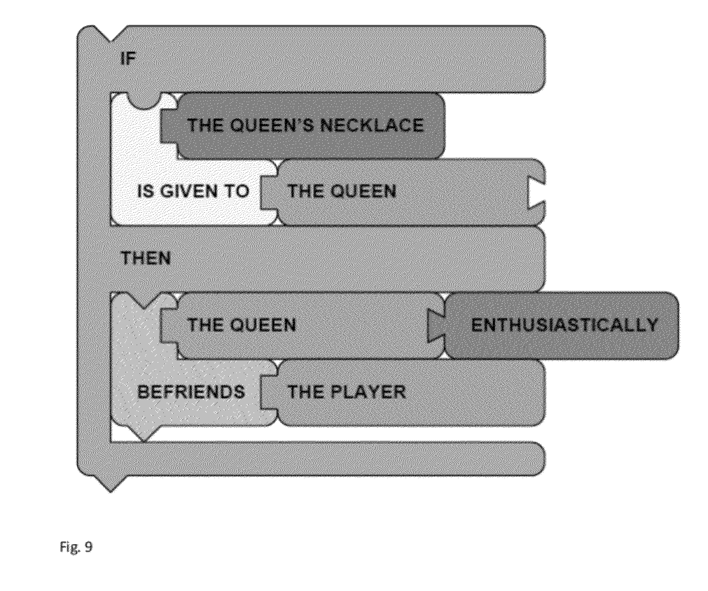

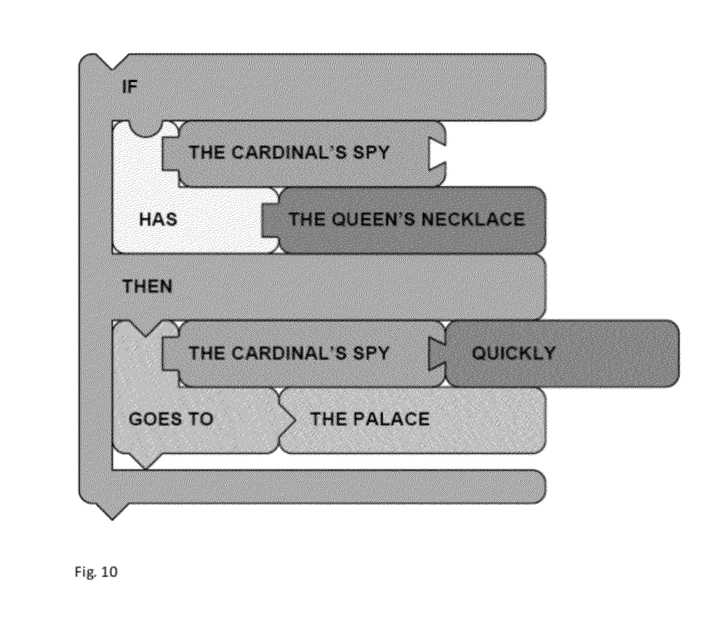

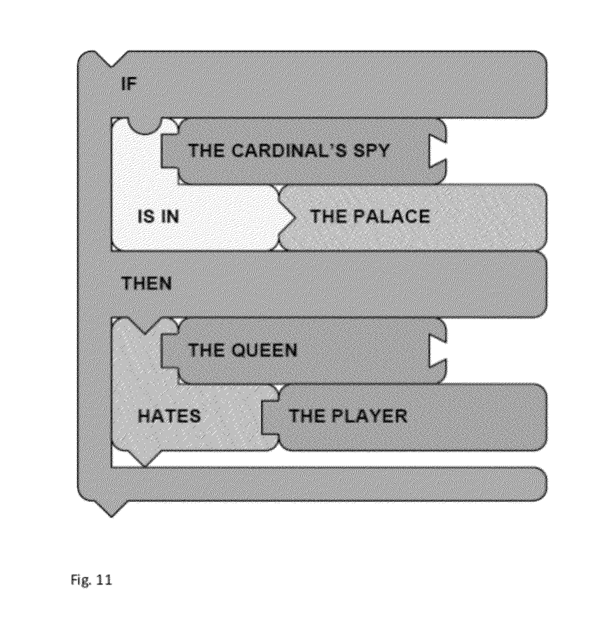

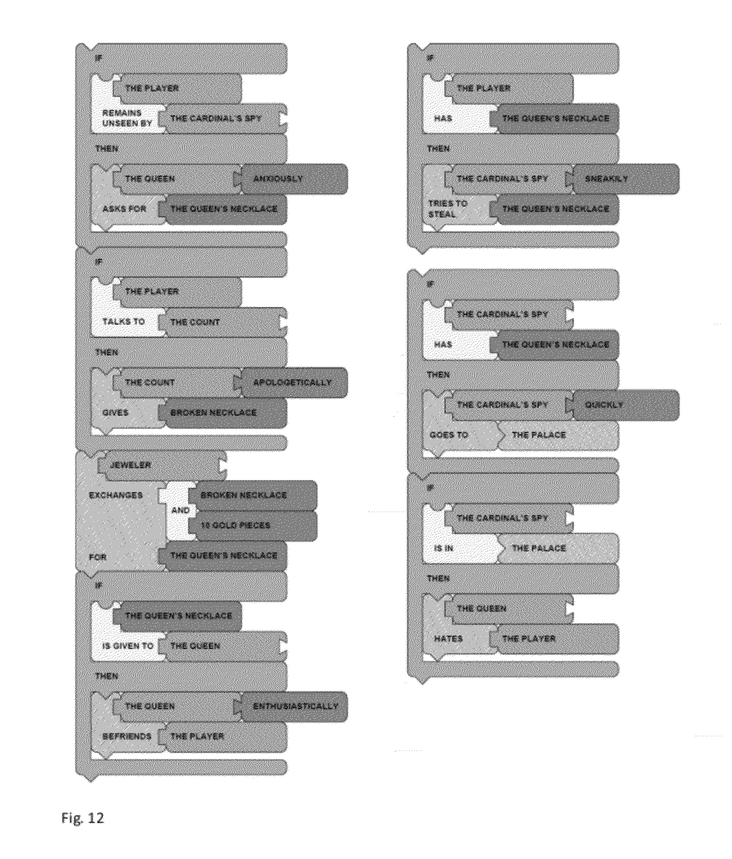

This is where the story blocks go.
Preferably, the graphical editor allows drag and drop operations to position building blocks. In a preferred embodiment shown in FIG. 5, context sensitive guidance may be provided to the designer based on blocks and their positions already present in the panes 23 and 25. In the example shown in FIG. 5, a list of possible emotions that are available to the designer are shown as available selections in a pop-up menu 25a.
The game engine, on receiving a story designed in this manner accesses the content database 30 and game element database 40 to retrieve the objects and render them in the displayed environment. An AI engine (not shown) may optionally be instructed to control character game elements based on the blocks and their configuration (such that emotions affect aggressiveness, whether the character will run away, talk to players etc).
The simple story used in example below is inspired by Alexandre Dumas' The Three Musketeers.
The scenario is that the queen must get her necklace back before people realize she has given it to her paramour, the Count. The Cardinal has tasked his spy with revealing her infidelity.
The player must find the Count and get the necklace back to the Queen. Unfortunately, the necklace has been broken and must be repaired first. Furthermore, once it is repaired, the spy will try to steal it and bring it back to his master . . . .
In order to produce this game element story, the designer first chooses a standard city map for the world. He then picks the characters from the people list and places them on the map (they then appear in the “selected” list):
The Queen and The Cardinal's Spy in the palace's throne room
The Count in one of the mansions
A Jeweller in one of the shops
   Using a default city is the simplest way to do it. If he wishes, the designer can also create his own from scratch, using buildings in the database.
   Each interaction between characters can be associated with dialog lines that are performed by the characters according to attributes such as their moods as described in co-pending, co-owned U.S. patent application Ser. No. 13/407,513, the contents of which are herein incorporated by reference. Character interactions can also be defined or made accessible including “talking” and handling items.
   For example, in order to make the opening scene a little bit more interesting than your average quest briefing, the scene may be designed such that: the Queen wants to ask the player for help, but she can't as long as the spy can see the player. Before he can talk to the Queen, the player will have to distract the spy or lead her somewhere away from the spy.
   This complex behaviour, as well as the urgency with which the Queen makes her request, can be represented simply by the blocks shown in FIG. 6.
   The blocks can be read in sequence and form plain English sentences: “If the player remains unseen by the Cardinal's spy, then the Queen anxiously asks for the Queen's necklace.”
   Blocks with different functions may be displayed as having different colors, patterns, shapes or textures. For example:
   Story structure blocks may be orange
   Conditions may be yellow
   Characters may be light red
   Characters' moods, denoted by adverbs, may be deep red
   Actions may be blue
   Objects may be purple
   Places may be green
   In the illustrated embodiment, the graphical editor portrays elements as blocks that fit like puzzle pieces, guaranteeing that they go in their right place. E.g. only conditions (yellow blocks) can fit the condition part of an “if/then” structure.
   Character moods are simply denoted by adverb blocks, as shown above. They influence how the character acts and delivers its dialog. Here, the Queen is anxious and will appear agitated and pressing.
   The game content generation system 20 may by default include access to basic content objects (such as generic monsters, basic actions and world areas) with more elaborate or functionally complex objections being purchasable via the game store 6. For example, complex conditions, actions and adverbs are prime candidates for being “sellable” items, since they add depth and flavour to the stories.
   Blocks are preferably chained in sequence to denote chronology. The chronology may not be absolute (so it illustrates order but can be broken by the player doing other things). For example, FIG. 7 is about asking the Count for the necklace, but the Count has broken it.
   Note that the designer doesn't need to explain how the player will find the Count. It can be easy or hard. He may have to ask NPCs, gain access to closed parts of the city, etc. This will be all automatically handled by the game engine 110 depending on where the user puts the Count in the world, what kind of behaviour he gives him and what game elements may be in place over those locations and people, etc.
   Just like the Queen, the Count has his acting influenced by an adverb. He will be fidgety and embarrassed.
   The player must then get the necklace fixed. When he finds a jeweller, the jeweller (an NPC) will tell him that he needs 10 gold pieces to do the job. Again, the designer doesn't need to specify how the player will obtain the gold pieces, it may be that he already has them, or it may be he needs to take on other missions to get them. This is simply shown as the blocks in FIG. 8.
   Finally, the player can get back to the Queen and give her back her necklace. His reward is the Queen's friendship as shown in FIG. 9, which can unlock other stories and be useful in stories involving nobles . . . .
   Even if it will be well acted, this story is very close to a fetch quest. If the designer wants to add some depth in the form of complications, the same system can be used to control autonomous NPCs. For instance, let's say that the spy will try to steal the repaired necklace from the player as soon as he has obtained it. The spy will then try to bring it back to the Cardinal. If he succeeds, the Queen will be dishonoured and will hold the player responsible.
   The “sneakily” adverb shows how flexible the system can be. For instance, it can induce a stealthy behaviour, making the spy avoid the player's front in order to successfully pick his pocket.
   Once the spy has the necklace, he runs (“quickly goes”) to the palace as is illustrated in FIG. 10.
   And if the spy reaches the palace, the mission has failed and the Queen now despises the player as shown in FIG. 11. Again, this outcome could open other stories, quests etc.
   FIG. 12 shows how all the blocks come together. This representation, a version derived from it or an encoded version of it is what would be saved and interpreted by the game engine 110 when the story is accessed.
   It will be appreciated that the system enables implicit storytelling. The designer doesn't need to describe how the player will stop the spy from reaching the palace if he successfully steals the necklace. It may be that the player will catch him and kill him, it may be he'll ask friends of his to detain him.
   Note that if the player gets the necklace back from the spy but leaves him alive, his stealing behaviour may be automatically reactivated (since the player has the necklace) and he will try to steal it again.
   As will be appreciated, such an embodiment enables a straightforward mechanism for designing stories coupled with a system that interprets needs, means and methods to intelligently produce complex open stories with easy to understand tools and content.
   It will be appreciated that the above described story is a very simple example designed with what could be seen as ad-hoc blocks. How the story unfolds will require additional specifications—for instance, setting up the conditions in which it can be played (the player can't already be hated by the Queen) and how the mission concludes/is aborted.
   Once the game element has been created, it is preferably saved or otherwise uploaded or provided to the game element database 40. Preferably, the game element database is hosted remotely to users so as to be centrally accessible to players of the world and avoid downtime should the designing user's system be inaccessible. The user can specify pre-requisite criteria such as required payment (typically a real world payment or some equivalent), player character type, level, skill set etc. that must be satisfied to access the game element. As game elements are described in a declaratory fashion referring to their base game elements, in one embodiment the database may be implemented as scripts or recipes defining how to combine elements to create more complex ones. In this manner, plots and quests need not be comprises of large data structures and could be relatively simple scripts referring to game elements defined in terms of their graphics etc in data elsewhere. Such scripts would be interpreted when accessed or in anticipation of being accessed to cause actual rendering of the game environment.

It is to be appreciated that certain embodiments of the invention as discussed below may be incorporated as code (e.g., a software algorithm or program) residing in firmware and/or on computer useable medium having control logic for enabling execution on a computer system having a computer processor. Such a computer system typically includes memory storage configured to provide output from execution of the code which configures a processor in accordance with the execution. The code can be arranged as firmware or software, and can be organized as a set of modules such as discrete code modules, function calls, procedure calls or objects in an object-oriented programming environment. If implemented using modules, the code can comprise a single module or a plurality of modules that operate in cooperation with one another.

Optional embodiments of the invention can be understood as including the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although illustrated embodiments of the present invention have been described, it should be understood that various changes, substitutions, and alterations can be made by one of ordinary skill in the art without departing from the present invention which is defined by the recitations in the claims below and equivalents thereof.

1. A computer game support system comprising:
a plot element data repository encoding an abstract representation of computer game plot elements; and,
a processor configured to execute computer program code for providing a gaming environment to one or more clients, the computer program code including:
computer program code configured to access said data repository and retrieve at least a part of said abstract representation;
computer program code configured to interpret said abstract representation to identify one or more objects associated said abstract representation and cause an operation in a computer game environment using said objects.

2. The computer game support system of claim 1, wherein said abstract representation is formed from a plurality of interlinkable blocks, each block representing a computer game element or an attribute of a computer game element, links between blocks defining relationships between said represented computer game elements or attributes.

3. The computer game support system of claim 2, further comprising a game element data repository encoding rendering data on one or more of said computer game elements, the computer game support system including computer program code configured to cause retrieval of said rendering data associated with the or each computer game element and computer program code to cause rendering in the computer game environment using the rendering data.

4. The computer game support system of claim 1, further comprising computer program code configured to operate a game store offering one or more purchasable elements to players of the game environment, the or each purchasable element having an associated abstract representation, wherein the computer game support system including computer program code configured to provide access to a player to said plot element in the computer game environment upon purchase via the game store.

5. The computer game support system of claim 1, further comprising computer program code configured to cause movement of objects in the computer game environment in response to inputs received from a player, said movement being processed independently of said plot elements.

6. A computer implemented game creation system comprising:
a plot element data repository encoding blocks for forming an abstract representation of computer game plot elements, said blocks being interlinkable, each block representing a computer game element or an attribute of a computer game element, links between blocks defining relationships between said represented computer game elements or attributes; and,
a processor configured to execute computer program code for providing a user interface for manipulating and linking said blocks to form said abstract representation.

7. The computer implemented game creation system of claim 6, wherein said user interface is a graphical user interface, said system including computer program code configured to graphically link blocks in dependence on user inputs.

8. The computer implemented game creation system of claim 6, wherein said system includes computer program code configured to accept user inputs on blocks to be selected to form said abstract representation.

9. The computer implemented game creation system of claim 6, further comprising computer program code configured to restrict access to one or more of said blocks until payment is made by the user.

10. The computer implemented game creation system of claim 6, further comprising a game data repository configured to receive and store an abstract representation created by a user, wherein game data repository is accessible by a computer game environment and is configured to provide stored abstract representations on demand to said game environment, said abstract representation being interpretable to cause a change in the game environment.

11. The computer implemented game creation system of claim 10, further comprising computer program code configured to provide access to a stored abstract representation upon receipt of a payment.

12. A computer implemented game design method comprising:
storing, in a data repository, data encoding blocks for forming an abstract representation of computer game plot elements, said blocks being interlinkable, each block representing a computer game element or an attribute of a computer game element,
links between blocks defining relationships between said represented computer game elements or attributes; and,
executing, by a processor, computer program code for providing a user interface for manipulating and linking said blocks to form said abstract representation.

13. The computer implemented game design method of claim 12, wherein said user interface is a graphical user interface, said method including accepting user inputs to cause graphical linking of said blocks.

14. The computer implemented game design method of claim 12, further comprising receiving one or more user inputs on a block to be selected to form said abstract representation and displaying said selected block in the user interface.

15. The computer implemented game design method of claim 12, further comprising receiving one or more user inputs on a block in the abstract representation and causing movement of said selected block in the abstract representation, wherein chronology of the plot element is dependent on the position of the blocks in the abstract representation.

16. The computer implemented game design method of claim 12, further comprising executing computer program code in a processor to restrict access to one or more of said blocks until payment is made by the user.

17. The computer implemented game design method of claim 12, further comprising operating a game data repository configured to receive and store an abstract representation created by a user, wherein game data repository is accessible by a computer game environment, the method further comprising providing stored abstract representations on demand to said game environment, said abstract representation being interpretable to cause a change in the game environment.

18. The computer implemented game design method of claim 17, further comprising executing computer program code in a processor to provide access to a stored abstract representation upon receipt of a payment.
